(19) United States
(12) Patent Application Publication
(10) Pub. No.: US 2013/0248076 A1
(43) Pub. Date: Sep. 26, 2013

(54) BEAD STRUCTURE FOR A PNEUMATIC TIRE

(71) Applicants: Peter Johann Cornelius Maus, Bullingen (BE); Roland Willibrord Krier, Wasserbillig (LU)

(72) Inventors: Peter Johann Cornelius Maus, Bullingen (BE); Roland Willibrord Krier, Wasserbillig (LU)

(21) Appl. No.: 13/429,520

(22) Filed: Mar. 26, 2012

(51) Int. Cl. B60C 15/06

(52) U.S. Cl. 152/541

(57) ABSTRACT

A pneumatic tire includes a tread extending circumferentially around an outer portion of the pneumatic tire; two sidewalls extending radially inward from the tread; a carcass ply extending radially inward through each sidewall; two annular bead portions securing radially inner portions of the carcass ply; and two apexes extending radially outward from each bead portion. The bead portions include a composite material constructed of resin-impregnated fabric layers including a resin, a hardener, an accelerator, and fibers.

### FIELD OF INVENTION

The present invention relates to pneumatic tires and, more specifically, to bead structures of pneumatic tires.

### BACKGROUND OF THE PRESENT INVENTION

The use of treads specifically designed for an axle of truck tires is well known. It is also known, however, that improvements are desired. First, stones may become trapped or held within the grooves of the tread. Such stones may damage the groove bottoms and the belt-package that lies beneath the tread. Such damage caused by stones is known as “stone drilling.”

Second, irregular wear may occur in the shoulder ribs of steer tires. Such irregular shoulder wear may produce peaking on the inside edge of a shoulder rib and drop off on the outside edge of the shoulder rib.

Third, even though cure molds used to produce steer tires are typically made with equal width shoulder and centerline grooves, those tires, when in use, may produce a footprint having shoulder grooves that are opened-up, or greater in width, than the centerline grooves. This opening of the shoulder grooves relative to the centerline grooves may result in a lower local net-to-gross ratio. Since the same load must be carried, the footprint length increases locally, yielding peaking around the shoulder grooves.

One conventional tire provides circumferential grooves that are wide enough to permit measurement of full intended non-skid depth by a tread gauge, yet narrow enough to prevent stones of significant size to enter the circumferential grooves.

### SUMMARY OF THE INVENTION

A pneumatic tire in accordance with the present invention includes a tread extending circumferentially around an outer portion of the pneumatic tire; two sidewalls extending radially inward from the tread; a carcass ply extending radially inward through each sidewall; two annular bead portions securing radially inner portions of the carcass ply; and two apexes extending radially outward from each bead portion. The bead portions include a composite material constructed of resin-impregnated fabric layers including a resin, a hardener, an accelerator, and fibers.

According to another aspect of the pneumatic tire, the fibers are glass fibers.

According to still another aspect of the pneumatic tire, the fibers are carbon fibers.

According to yet another aspect of the pneumatic tire, the fibers comprise both glass fibers and carbon fibers.

According to still another aspect of the pneumatic tire, the apexes comprise a composite material constructed of resin-impregnated fabric layers including a resin, a hardener, an accelerator, and fibers.

According to yet another aspect of the pneumatic tire, each bead portion comprises an integral structure with an associated apex.

According to still another aspect of the pneumatic tire, the uncured bead portions form a first liquid component mixture having a weight of between 0.08 kg and 1.20 kg resin, between 0.012 kg and 0.018 kg hardener, and between 0.003 kg and 0.007 kg accelerator.

According to yet another aspect of the pneumatic tire, the integral structure forms a first liquid component mixture having a weight of between 0.08 kg and 1.20 kg resin, between 0.012 kg and 0.018 kg hardener, and between 0.003 kg and 0.007 kg accelerator.

According to still another aspect of the pneumatic tire, the resin-impregnated fabric layers are manufactured into a final shape of the bead portions.

According to yet another aspect of the pneumatic tire, the resin-impregnated fabric layers are cut and placed one above the other into a mold that corresponds to the dimensions of the bead portions.

According to still another aspect of the pneumatic tire, the fibers have circular cross-sections.

According to yet another aspect of the pneumatic tire, the fibers have rectangular cross-sections.

According to still another aspect of the pneumatic tire, the fibers have triangular cross-sections.

According to yet another aspect of the pneumatic tire, the fibers are oriented radially.

According to still another aspect of the pneumatic tire, the fibers are oriented axially.

According to yet another aspect of the pneumatic tire, the fibers are oriented circumferentially.

### BRIEF DESCRIPTIONS OF THE DRAWINGS

The invention will be described by way of example and with reference to the accompanying drawings in which:

FIG. 1 is a schematic cross-section view of an example tire for use with the present invention.

FIG. 2 is a schematic front elevation of the example tire of FIG. 1

### DEFINITIONS

“Axial” and “axially” means lines or directions that are parallel to the axis of rotation of the tire.

“Block Element” means a tread element defined by a circumferential groove or shoulder and a pair of lateral extending grooves.

“Circumferential” means lines or directions extending along the perimeter of the surface of the annular tread perpendicular to the axial direction.

“Equatorial Plane (EP)” means the plane perpendicular to the tire's axis of rotation and passing through the center of its tread.

“Groove” means an elongated void area in a tread that may extend circumferentially or laterally about the tread in a straight, curved, or zigzag manner. Circumferentially and laterally extending grooves sometimes have common portions. The “groove width” is equal to the tread surface area occupied by a groove or groove portion, the width of which is in question, divided by the length of such groove or groove portion; thus, the groove width is it average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves which they interconnect, they are regarded as forming “tire bars” tending to maintain a rib-like character in the tread region involved.

“Lateral” means an axial direction.

“Net-to-gross ratio” means the total area of ground contracting tread elements between the lateral edges around the entire circumference of the tread divided by the gross area of the entire tread between the lateral edges.

“Radially” and “radially” means directions radially toward or away from the axis of rotation of the tire.

“Radial Ply Tire” means a belted or circumferentially-restricted pneumatic tire in which the ply cords which extend from bead to bead are laid at cord angles between 65 degrees and 90 degrees with respect to the equatorial plane of the tire.

“Rib” means a circumferentially extending strip of rubber of the tread which is defined by at least one circumferential groove and either a second such groove or a lateral edge, the strip being laterally undivided by full-depth grooves.

“Shoulder” means the upper portion of sidewall just below the tread edge; tread shoulder or shoulder rib means that portion of the tread near the shoulder.

“Sipe” means small slots molded into the tread elements of the tire that subdivide the tread surface and improve traction.

“Tread” means a rubber or elastomeric component including that portion of the tire that comes into contact with the road under normal inflation and load.

“Tread element” or “traction element” means a rib or a block element.

### DETAILED DESCRIPTION OF AN EXAMPLE EMBODIMENT

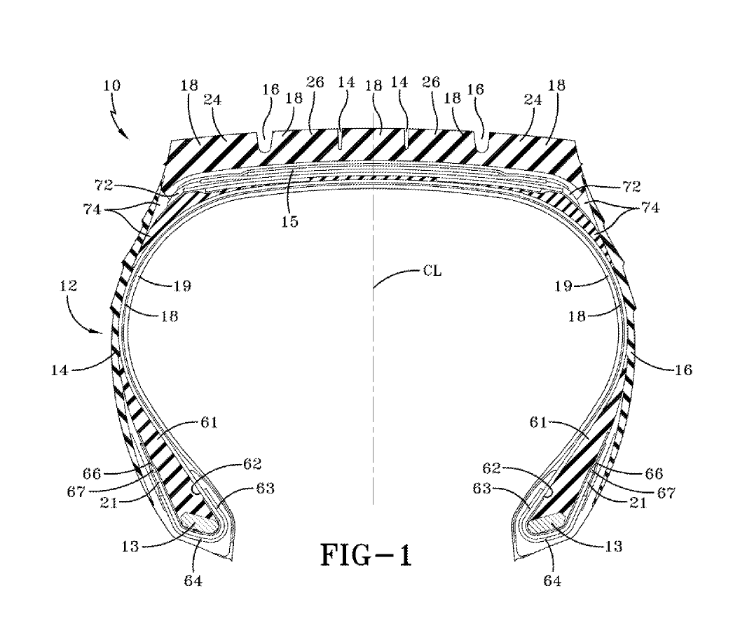

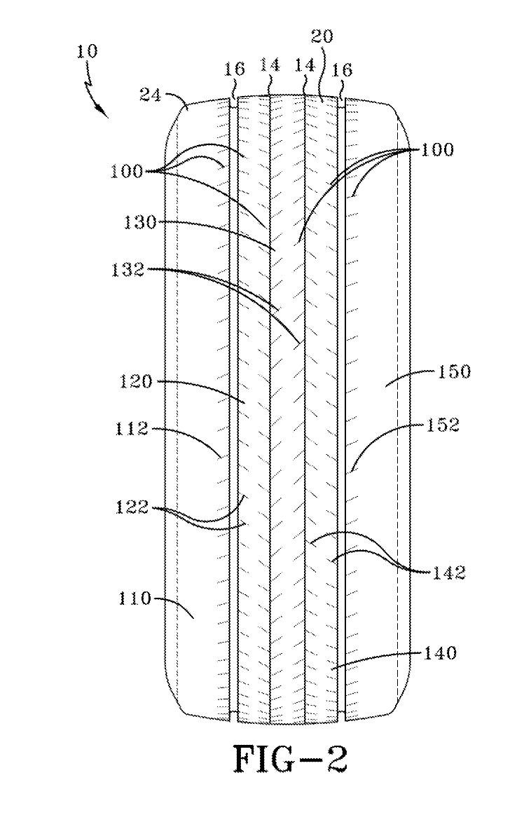

FIGS. 1 and 2 show an example tire 10 for use with the present invention. The tire 10 has a tread 20 and a casing 12. The casing 12 has two sidewalls 14, 16, one or more radial plies 18 extending from, and wrapped about, two annular beads 13, and a belt reinforcement structure 15 located radially between the tread 20 and the ply or plies 18.

The plies 18 and the belt reinforcement structure 15 may be cord reinforced elastomeric material. The cords may be, for example, steel wire filaments and the elastomer may be, for example, a vulcanized rubber material. Conventionally, the annular beads 13 have steel wires wrapped into a bundle forming an inextensible bead core. An innerliner component 19, for example a halobutyl rubber, may form a somewhat air impervious chamber to contain the air pressure when the tire 10 is inflated.

The tire 10 may further include an elastomeric apex 61 radially disposed above each bead 13. A turnup 21 of the ply 18 in each bead area may be reinforced with a flipper 62, a chipper 63, a gum and fabric chafer 64, a gum strip 66, and/or elastomeric wedges 67. Additionally, the belt reinforcement structure 15 may include a gum strip of rubber material 72 and/or a plurality of elastomeric strips or wedges 74 in the lateral extremes or edges of the belt reinforcement structure 15 in proximity of the lateral shoulders of the tread 20. Although not required to the practice of the inventive concept, these features are disclosed as features employed by an example embodiment.

The example tread 20 may have a predetermined non-skid depth and four circumferential grooves including two centerline grooves 14 and two shoulder grooves 16 that divide the tread 20 into five circumferential ribs 18. The shoulder grooves 16 may have a greater width than the centerline grooves 14 thereby mitigating groove cracking. The narrower centerline grooves 14 may optimize rolling resistance and pressure distribution throughout the tread 20. Laterally extending blind sipes 100 may extend at least partially across the five ribs 18 of the tread 20 to form five circumferentially extending ribs 18 including two shoulder ribs 24, two riding ribs 26, and a center rib 28. Further, one end of the blind sipes 100 may be enclosed within the edges of the ribs 18 for optimizing wetskid performance.

In accordance with the present invention, the beads 13 and/or apexes 61 may comprise a fiber composite material constructed of resin-impregnated fiber fabric layers. Accordingly, the beads 13 and/or apexes 61 may comprise a resin, a hardener, an accelerator, and fibers of glass and/or carbon. For example, the uncured beads 13 and/or apexes 61 may form a first liquid component mixture having a weight of 0.1 kg resin, 0.012 kg to 0.018 kg hardener, and 0.003 kg to 0.007 kg accelerator, or equivalent ratio. Each bead 13 and apex 61 may also be a single piece constructed in accordance with the present invention.

Even though conventional steel beads are comparatively inexpensive to manufacture and reliable in operation, any innovation that can lighten a tire without detracting from performance in any other way is desirable for improving at least rolling resistance. Such fiber composite beads 13 and/or apexes 61 may be produced from resin-impregnated fiber layers, which may be known under a term “prepreg”.

These resin-impregnated fiber layers may be manufactured in the desired shape and/or cut and placed one above the other into a mold that corresponds to the dimensions of the beads 13 and/or apexes 61. Unfinished beads 13 and/or apexes 61 may be placed in the mold under the action of pressure and heat cured.

The resin-impregnated fibers and resin-impregnated fiber layers may be variously sized and oriented. For example, the fibers may be oriented radially away from, axially along, or circumferentially relative to the axis of rotation of the beads 13. All or a portion of the fibers may be cylindrical, rectangular, triangular, etc. Fibers may be 10.0 mm in length up to the entire circumference of the beads 13. Cross-sectional areas of the fibers may also be constant or vary. The relationship between the fibers and resin may be such that the beads 13 and/apexes 61 may withstand extreme stresses occurring during the tire's operation and maximum service life.

The invention has been described with reference to the example embodiment. Modifications and alterations may occur to others upon a reading and understanding of the specification and claims. It is intended to include all such modifications and alterations in so far as they come within the scope of the appended claims or equivalents thereof.

Having thus described the invention, we claim:

1. A pneumatic tire comprising:
a tread extending circumferentially around an outer portion of the pneumatic tire;
two sidewalls extending radially inward from the tread;
a carcass ply extending radially inward through each sidewall;
two annular bead portions securing radially inner portions of the carcass ply; and
two apexes extending radially outward from each bead portion,
the bead portions comprising a composite material constructed of resin-impregnated fabric layers including a resin, a hardener, an accelerator, and fibers.

2. The pneumatic tire as set forth in claim 1 wherein the fibers are glass fibers.

3. The pneumatic tire as set forth in claim 1 wherein the fibers are carbon fibers.

4. The pneumatic tire as set forth in claim 1 wherein the fibers comprise both glass fibers and carbon fibers.

5. The pneumatic tire as set forth in claim 1 wherein the apexes comprise a composite material constructed of resin-impregnated fabric layers including a resin, a hardener, an accelerator, and fibers.

6. The pneumatic tire as set forth in claim 5 wherein each bead portion comprises an integral structure with an associated apex.

7. The pneumatic tire as set forth in claim 6 wherein the fibers are glass fibers.

8. The pneumatic tire as set forth in claim 6 wherein the fibers are carbon fibers.

9. The pneumatic tire as set forth in claim 6 wherein the fibers comprise both glass fibers and carbon fibers.

10. The pneumatic tire as set forth in claim 1 wherein the uncured bead portions form a first liquid component mixture having a weight of between 0.08 kg and 1.2 kg resin, between 0.012 kg and 0.018 kg hardener, and between 0.003 kg and 0.007 kg accelerator.

11. The pneumatic tire as set forth in claim 6 wherein the integral structure forms a first liquid component mixture having a weight of between 0.08 kg and 1.2 kg resin, between 0.012 kg and 0.018 kg hardener, and between 0.003 kg and 0.007 kg accelerator.

12. The pneumatic tire as set forth in claim 1 wherein each bead portion comprises an integral structure with an associated apex.

13. The pneumatic tire as set forth in claim 1 wherein the resin-impregnated fabric layers are manufactured into a final shape of the bead portions.

14. The pneumatic tire as set forth in claim 1 wherein the resin-impregnated fabric layers are cut and placed one above the other into a mold that corresponds to the dimensions of the bead portions.

15. The pneumatic tire as set forth in claim 1 wherein the fibers have circular cross-sections.

16. The pneumatic tire as set forth in claim 1 wherein the fibers have rectangular cross-sections.

17. The pneumatic tire as set forth in claim 1 wherein the fibers have triangular cross-sections.

18. The pneumatic tire as set forth in claim 1 wherein the fibers are oriented radially.

19. The pneumatic tire as set forth in claim 1 wherein the fibers are oriented axially.

20. The pneumatic tire as set forth in claim 1 wherein the fibers are oriented circumferentially.
